(19) United States
(12) Patent Application Publication
(10) Pub. No.: US 2010/0161509 A1
(43) Pub. Date: Jun. 24, 2010

(54) INTELLECTUAL PROPERTY MANAGEMENT METHOD AND INTELLECTUAL PROPERTY BANK SYSTEM

(75) Inventors: Beng-Yaw Wang, Hsinchu City (TW); Chi-Hsiung Huang, Taipei County (TW); Yen-Pong Jou, Taoyuan County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: INDUSTRIAL TECHNOLOGY RESEARCH INSTITUTE, Hsinchu (TW)

(21) Appl. No.: 12/548,444

(22) Filed: Aug. 27, 2009

(30) Foreign Application Priority Data
Dec. 24, 2008 (TW) 97150535

(51) Int. Cl. G06Q 40/00; G06Q 50/00; G06Q 10/00

(52) U.S. Cl. 705/36 R; 705/37

(57) ABSTRACT

An intellectual property management method and an intellectual property bank system are provided. The intellectual property management method includes raising funds to set up a fund company by a plurality of members to purchase intellectual properties. The intellectual property management method also includes setting up an intellectual property management company to assist purchasing and managing the purchased intellectual properties of the fund company. The intellectual property management method further includes selling the intellectual properties to the members when a special event occurs to the members such that the members can own the intellectual properties to deal with the special event. Therefore, the intellectual property management method can provide the members with powerful protection with fewer resources and lower costs.

### CROSS-REFERENCE TO RELATED APPLICATION

This application claims the priority benefit of Taiwan application serial no. 97150535, filed on Dec. 24, 2008. The entirety of the above-mentioned patent application is hereby incorporated by reference herein and made a part of specification.

### BACKGROUND OF THE INVENTION

2. Field of the Invention

The present invention relates an intellectual property management method and more particularly, to an intellectual property management method and an intellectual property bank system in which a plurality of members can collaboratively purchase, manage, and make use of intellectual properties.

2. Description of Related Art

Owning intellectual properties has given corporations a winning edge in the modern global market competitions. In order to win market shares and develop preemptive products, the litigation or assertion of intellectual properties has become a tool for a corporation to survive and to defeat its opponents. Patent proprietorship is the most basic defense tools and has multiple advantages as well. Not only can a corporation amass intangible assets by obtaining patents to prove its ability to innovate, but the quality and quantity of patents are also the best bargaining chips at negotiations. Thus, patent negotiations have become an essential lesson for corporations involved in global market competitions.

For the high-tech industry, owning or obtaining patents is undoubtedly the winning weapon for a corporation to seize more territories and is the key to its competitiveness in the business. However, the accumulation and management of patents is a long term task. The more patents a corporation has, the more tightly weaved the patent network or patent portfolio is. The corporation may then increase its chance at out-licensing, in-licensing, or litigation.

However, application and maintenance of a great number of patents has very high costs. Thus, a corporation has to allocate great resources in response to the increase in the number of patents. In addition, there are many cases where a corporation has reached certain effects in the number of patents but still encounters many obstacles related to patent issues during operation. Therefore, an operation method of patent pool has become a popular topic of discussion in recent years. The patent pool is also referred to as patent joint licensing, which is a type of technology licensing in a broad sense. The patent pool allows mutual accumulation of bargaining chips for negotiations through establishment of a strategic alliance between industries. Meanwhile, manufacturers can make full use of the patent joint licensing agreement to integrate research resources and allow manufacturers to efficiently apply the most advanced research results.

However, currently, such patent pool is usually formed, as a result of an agreement, by a plurality of manufacturers holding core patent technologies in a certain technical field. The core patents held by each member constitute the admission ticket to the patent pool. In other words, the patent pool achieves merely mutual licensing among manufacturers currently holding patents. However, with the vast and rapid development in technology, when a potential demand or application for a new technology emerges from the market, manufacturer hopes to quickly search and own related patent portfolios so as to be able to meet such a demand or provide such an application. This kind of service, however, is not easily accomplished through the simple patent pool. In addition, the conventional patent pool includes a great number of patents which many members may not need. Furthermore, under the conventional patent pool structure, the members do not have a complete and fast message communication network. Hence, a system for effectively searching, purchasing, using, and managing patents is a topic for manufacturers to ponder upon.

### SUMMARY OF THE INVENTION

The present invention provides a method for managing intellectual properties through a computer/network system which effectively manages as well as uses intellectual properties and provides members with strong protection of the intellectual properties from infringement lawsuits by other competitors.

The present invention provides an intellectual property bank system which effectively manages intellectual properties and provides members with strong protection of the intellectual properties from infringement lawsuits by other competitors.

The present invention provides a method for managing intellectual properties through a computer/network system. The method includes configuring a fund module, an intellectual property (IP) management module, and an IP database. In the present method, each fund module corresponds to a fund company established with capital raised by a plurality of members based on a specific technical field. Each fund module connects to corresponding members via a first communication network. Furthermore, the IP management module corresponds to an IP management company. The method also includes, by the IP management module, periodically collecting and storing a plurality of intellectual properties to be sold or licensed in the IP database according to a request from each fund module and also professionally analyzing and categorizing the plurality of intellectual properties through a computer software, and thereby obtaining a result. In addition, the method further includes, by the IP management module, generating an IP purchase suggestion and sending the suggestion to each fund module according to the analysis and categorization results from the IP database, and sending a purchase request for purchasing intellectual properties to the seller of the intellectual properties via a second communication network based on an IP purchase decision generated from each fund module. The method further includes, by the IP management module, recording information related to the purchased intellectual properties in the IP database. In the present method, a member may send a transfer request for obtaining the purchased intellectual properties to the corresponding fund module. The corresponding fund module determines whether to approve the transfer request and sends a sale decision to the requesting member via the first communication network. When the corresponding fund module approves the transfer request, the member sending the request owns the rights to the obtained intellectual properties. If a plurality of the members simultaneously sent a transfer request, a member that is granted the transfer request is generated through bidding via the first communication network, or they could jointly own the IP.

The present invention provides an IP bank system including at least a fund module and an IP management module. Each fund module corresponds to a fund company. Each fund company has a plurality of members and capital supplied by the members of the fund company. Each fund module connects to the members through the first communication network. The IP management module corresponds to the IP management company and couples to the fund module through a connection. The IP management module periodically collects and stores a plurality of patents to be sold in a specific technical field in the IP database according to a request from the fund module. The IP management module professionally analyzes and categorizes the intellectual properties through a computer software, thereby obtains a result, and makes an IP purchase suggestion to each fund module. Each fund module then sends an IP purchase decision to the IP management module based on the IP purchase suggestion. In the present IP bank system, the IP management module further negotiates with the seller of the intellectual properties via the second communication network according to the IP purchase decision. The fund module then purchases the intellectual properties according to the negotiation outcome. In addition, when the members send transfer requests for obtaining the purchased intellectual properties to the fund module via the first communication network, the fund module determines whether to approve the transfer requests and sends sale decisions to the members via the first communication network. When the fund module approves the transfer requests, the members may own the rights to the sold intellectual properties within a contract period. If a plurality of the members simultaneously sent transfer requests respectively, a member that is granted the transfer request is generated through bidding via the first communication network, or they could jointly own the IP.

In view of the above, the present invention assists members in purchasing and selling intellectual properties through a fund company and an IP management company, and thus effectively manages intellectual properties of the members as well as reduces management costs. In addition, through the IP bank system, message delivery between the find company and the IP management company, and IP search, professional analysis as well as categorization are accomplished automatically. A result is thereby obtained to provide transaction of intellectual properties.

In order to make the aforementioned and other objects, features and advantages of the present invention more comprehensible, several embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view illustrating operation of an IP bank according to an exemplary embodiment of the present invention.

FIG. 2 is a schematic block diagram illustrating an IP bank system according to an embodiment of the present invention.

FIG. 3 is a schematic block diagram of a fund module according to an exemplary embodiment of the present invention.

FIG. 4 is a schematic block diagram of an IP management module according to an exemplary embodiment of the present invention.

FIG. 5 is a flow chart illustrating operation of an IP management method according to an exemplary embodiment of the present invention.

### DESCRIPTION OF EMBODIMENTS

In the IP management method of the present invention, members (i.e. manufacturers) establish individual fund companies according to various specific technical fields, and a professional IP management company assists all the fund companies in managing and using the intellectual properties (e.g. patents, copy rights, trademark, etc.) thereof so that the intellectual properties shared by the members is effectively purchased, used, and licensed. Here, the operation mode made with the members, the fund companies, and the IP management company is referred to as the Intellectual Property Bank. The following are detailed descriptions of the present invention in association with the accompanied figures.

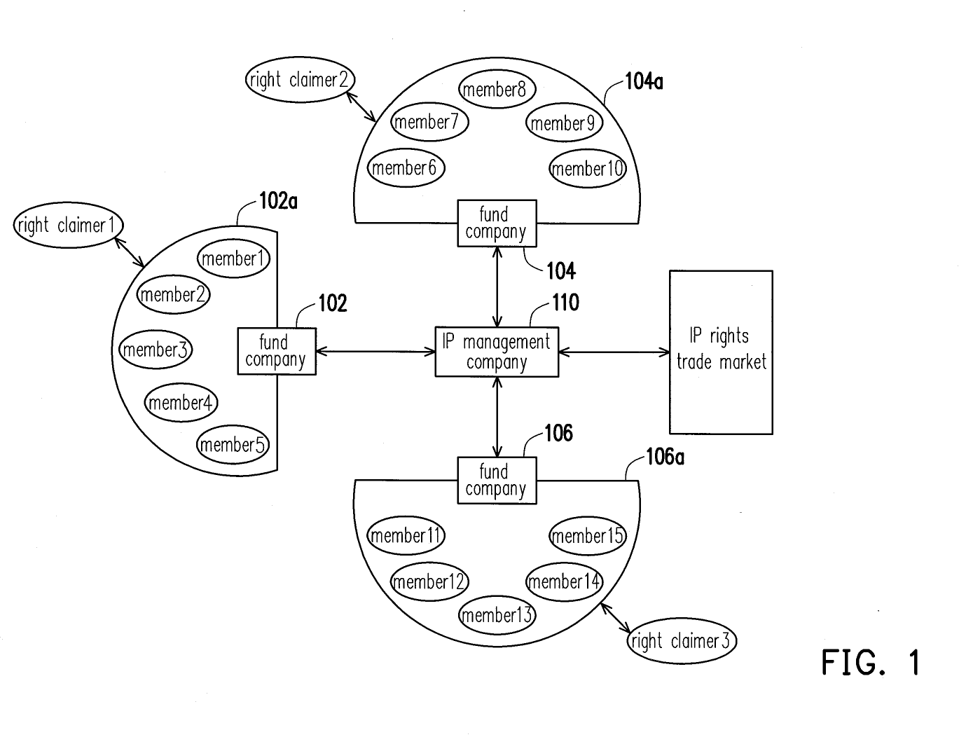

FIG. 1 is a schematic view illustrating operation of an IP bank according to an exemplary embodiment of the present invention.

Referring to FIG. 1, an IP bank 100 includes members 1˜15, a fund company 102, a fund company 104, a fund company 106, and an IP management company 110.

The members 1˜15 in the IP bank 100 are users or demanders of intellectual properties. For example, the members are manufacturers of related technical fields (e.g. notebook computers, wireless communication, flat panel display, integrated circuit, or light emitting diode).;

The fund companies 102, 104, and 106 are established by members among the members 1˜15 who belong to a similar technical field by means of raising capital. In the exemplary embodiment, the find company 102 is established by the members 1˜5, the fund company 104 is established by the members 6˜10, and the find company 106 is established by the members 11˜15. The members (e.g. the members 1˜5) establishing the fund company (e.g. the fund company 102) may be manufacturers of a supplier-and-buyer relationship or manufacturers making same products. For example, the members are mainly corporations, and the number of members of each fund company is preferably no more than 5. It should be noted that the present exemplary embodiment uses 3 fund companies for the purpose of illustration, which is not intended to limit the present invention. The number of the fund companies can be set according to the technical fields to which the members belong.

In the present exemplary embodiment, the fund companies (i.e. the fund companies 102, 104, and 106) are used to purchase intellectual properties (e.g. patents) of specific technical fields, wherein one find company is established for one specific technical field. The fund company does not have regular employees and related decisions thereof are made by members establishing the fund company at the board of directors. For example, the fund company 102 belongs to the field of notebook computers and the members 1˜5 are manufacturers which produce or sell notebook computers. The fund company 104 belongs to the field of wireless communication and the members 6˜10 are manufacturers which produce wireless communication equipment. The fund company 106 belongs to the field of flat panel display technology and the members 11˜15 are manufacturers which produce flat panel displays.

In one exemplary embodiment of the present invention, patents purchased by each fund company are provided to the members of the fund company in a non-exclusive licensing manner. In addition, each fund company may also license purchased patents to a party other than members of the fund company or members of the IP bank in exchange for license fees or other compensation. In other words, for each fund company, the members of the IP bank 100 have various levels of rights to the intellectual properties purchased by the fund company in the IP bank 100.

The IP management company 110 is a company capable of professionally managing intellectual properties. In the exemplary embodiment of the present invention, the IP management company 110 is responsible for monitoring and analyzing intellectual properties of specific technical fields, providing purchase suggestions to the fund companies (i.e. the fund companies 102, 104, and 106), managing the purchased intellectual properties, assisting in selling and licensing of the purchased intellectual properties, providing legal counsel regarding intellectual properties, trade and brokerage service of intellectual properties, etc.

Specifically, the IP management company 110 is mainly entrusted by the members 1˜15 to offer services related to intellectual properties to the fund companies 102, 104, and 106.

For example, according to requests from the fund companies 102, 104, and 106, the IP management company 110 periodically searches an IP trade market for intellectual properties to be sold, analyzes patent portfolios suitable for the fund companies 102, 104, and 106, and provides IP purchase suggestions to the fund companies 102, 104, and 106. Furthermore, when the fund companies 102, 104, and 106 decide to purchase intellectual properties from the IP trade market, the IP management company 110 undertakes negotiations with the seller and assists the fund companies 102, 104, and 106 obtain the intellectual properties.

For example, the IP management company 110 may provide relevant suggestions to the members 1˜15 of the fund companies 102, 104, and 106 regarding licensing or selling intellectual properties according to the conditions of use and assist the fund companies 102, 104, and 106 in selling and licensing the owned intellectual properties.

In addition, when the fund companies 102, 104, and 106 purchased a patent which is still in application, the IP management company 110 is responsible for tasks such as time and process control as well as prosecution of the patent application.

In one exemplary embodiment of the present invention, the IP management company 110 provides analysis reports on patent map, consultation reports on IP laws, or suggestion reports on IP application to the fund companies as reference for making decisions.

In the exemplary embodiment of the present invention, the IP management company 110 may obtain compensation by charging a management fee from the fund companies 102, 104, and 106 or take commission or bonus from the purchase of intellectual properties.

It should be noted that according to an exemplary embodiment of the IP bank 100 in the present invention, after the fund companies 102, 104, and 106 purchase intellectual properties (e.g. patents) and when a special event happens (e.g. a patent infringement lawsuit), a member of the fund companies 102, 104, and 106 may temporarily or permanently own the patent purchased by the fund companies and may engage in the defense of the rights to the patent based on the ownership to the patent. In other words, the fund companies 102, 104, and 106 respectively form IP protection networks 102a, 104a, and 106a for their members, and the members of each fund company are able to defend themselves in infringement lawsuits instituted by other manufacturers (e.g. right claimers 1, 2, and 3 in FIG. 1) under the IP protection networks.

For example, if the member 1 is a defendant of a patent infringement lawsuit, the member 1 may search the patents purchased by the fund company 102 which may be used as bargaining chips at negotiations in the patent infringement lawsuit and obtain ownership of the patents so as to fend off the right claimer 1. For example, the member 1 may have priority in obtaining ownership of the patents from the fund company 102 at the cost price thereof plus some profit. In addition, the member 1 may also sell the obtained patents back to the fund company 102 at a discount from the purchase price thereof.

Furthermore, in another exemplary embodiment of the present invention, if the member 1 and the member 2 are both defendants of infringement lawsuits, the member 1 and the member 2 may both have priority in obtaining ownership of patents helpful in the defense in the infringement lawsuits or alternatively, the member 1 and the member 2 may individually obtain ownership of the required patents by means of bidding. For example, the member 1 and the member 2 obtain ownership of the patents from the fund company 102 at the cost price thereof plus some profit. Alternatively, the member 1 and the member 2 individually obtain ownership to the patents by bidding for the patents at prices higher than the cost price of the fund company plus some profit. Similarly, the member who obtained the patents may also sell the obtained patents back to the fund company 102 at a discount from the purchase prices thereof. Or they maybe jointly obtain ownership to the patents.

In addition, in another exemplary embodiment of the present invention, if a non-member of the fund company or another buyer 254 is interested in purchasing intellectual properties of the fund company, members of the fund company may decide on whether to make the sale. If the member 6 or a buyer who is not a member of the IP bank 100 wishes to purchase a patent owned by the fund company 102, the members 1˜5 of the fund company 102 jointly decide whether to sell the patent to the member 6 or the buyer who is not a member of the IP bank 100.

It should be mentioned that in the exemplary embodiment, when the members 1˜15 need to purchase intellectual properties from the fund companies 102, 104, and 106 due to lawsuits, the IP management company 110 and the fund companies 102, 104, and 106 merely facilitate in the selling of the intellectual properties and related matters rather than engaging in the lawsuits involving the members 1˜15.

In light of the above, in the present exemplary embodiment, the establishment of the fund company is primarily aimed at providing protection for the members' common intellectual properties, lowering risks of the members being sued for infringement, reducing loss resulted from an outside party claiming rights, and curtailing the member's costs for maintaining a great amount of intellectual properties and a secondary aim is to license the patents to non-members of the fund company when necessary. Furthermore, the fund company makes appropriate profit through the sale and license of the intellectual properties to continuously purchase and maintain more intellectual properties so as to form more powerful and fortified IP protection. In addition, the IP management company reduces cost of each fund company at maintaining intellectual properties by providing each fund company with professional IP management service and resource integration.

It should be mentioned that as the above-mentioned, in the IP bank 100 of the present exemplary embodiment, the fund companies 102, 104, 106 do not have regular employees and decisions thereof are made by the members 1˜15. The purchase and management of intellectual properties are entrusted to the IP management company 110. Therefore, information communication and operations in the IP bank 100 are required to be accomplished through an IP bank system 200.

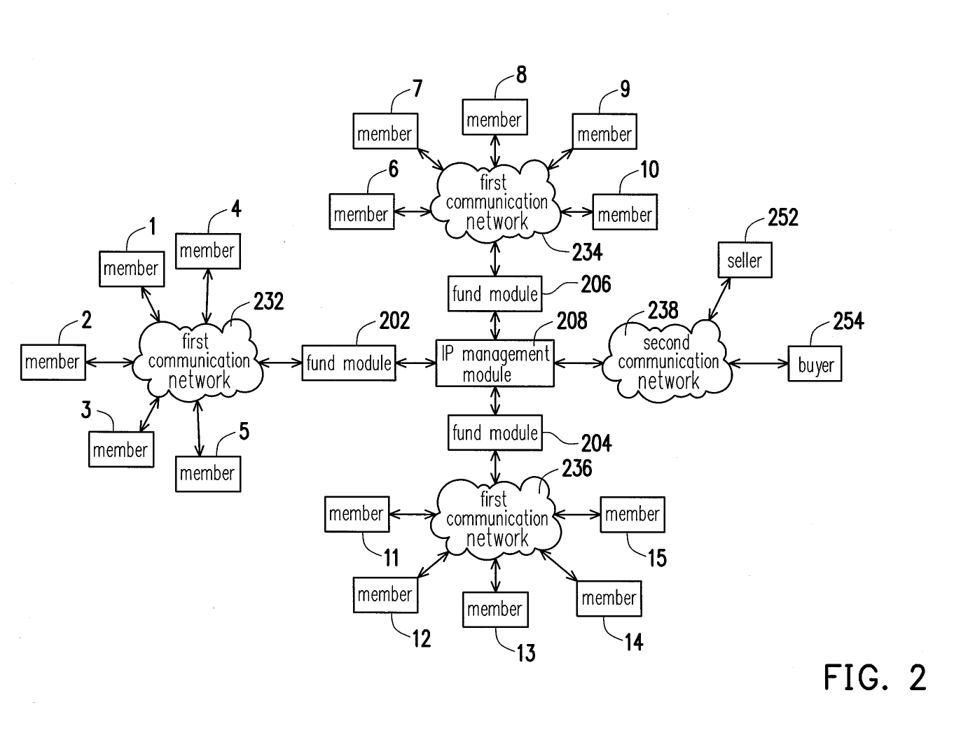

FIG. 2 is a schematic block diagram illustrating an IP bank system 200 according to an embodiment of the present invention.

Referring to FIG. 2, the IP bank system 200 includes a fund module 202, a fund module 204, and a fund module 206, and an IP management module 208.

The fund modules 202, 204, and 206 are configured in correspondence to fund companies 102, 104, and 106. Structure and operation of the fund modules 202, 204, and 206 are the same. Thus, a description on the fund module 202 is given below for the purpose of illustration.

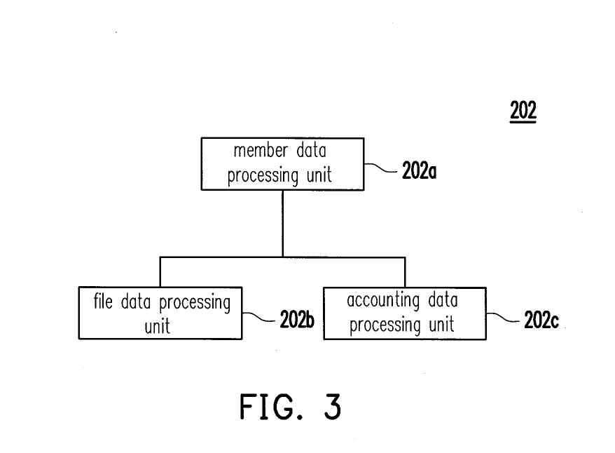

FIG. 3 is a schematic block diagram of a fund module 202 according to one exemplary embodiment of the present invention.

Referring to FIG. 3, the fund module 202 deals with relevant operations of the fund company 102. The fund module 202 includes a member data processing unit 202a, a file data processing unit 202b, and an accounting data processing unit 202c.

Because members 1˜5 form the fund company 102 and make relevant decisions thereof, the member data processing unit 202a records data of the members 1˜5 and provides logging and registration for the members 1˜5.

Furthermore, the fund module 202 provides the members 1˜5 with the IP purchase suggestions, analysis reports on patent map, consultation reports on IP laws, or suggestions on IP application supplied by the IP management company 110 through a first communication network 232. The fund module 202 also receives relevant decisions from the members 1˜5 and sends the decisions to the IP management company 110. The file data processing unit 202b archives correspondence among the fund company 102, the IP management company 110, and the members 1˜5.

In addition, main operations of the fund company relate to purchase, sale, and license of intellectual properties. Therefore, the accounting data processing unit 202c stores records such as capital paid by the members 1˜5, subsequent purchase and sale of intellectual properties, and management fee paid to the IP management company 110.

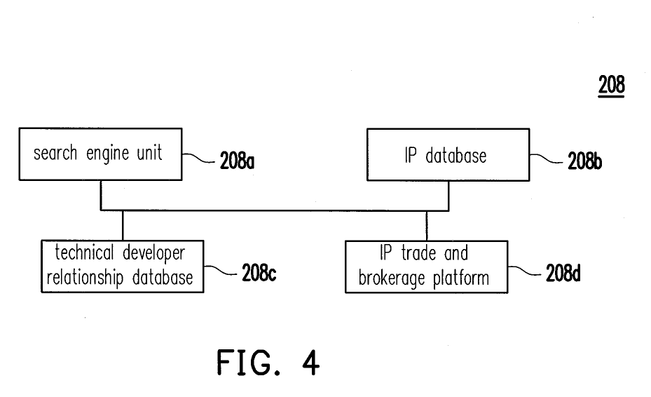

An IP management module 208 is configured in correspondence to the IP management company 110 for dealing with relevant operations of the IP management company 110. FIG. 4 is a schematic block diagram of an IP management module 208 according to one exemplary embodiment of the present invention.

Referring to FIG. 4, the IP management module 208 mainly includes a search engine unit 208a and an IP database 208b.

The search engine unit 208a searches for intellectual properties to be sold in the IP market. For example, the fund company 102, through the corresponding fund module 202, requests the IP management module 208 of the IP management company 110 to search for intellectual properties to be sold in the specific technical field. When the IP management module 208 receives the request, the search engine unit 208a searches for intellectual properties to be sold and information of the seller through a second communication network 238.

The IP database 208b stores files of the intellectual properties purchased by each fund company.

In addition, in order for the search engine unit 208a to effectively search for intellectual properties to be sold in the specific technical field, in one exemplary embodiment of the present invention, the IP management module 208 further includes a technical developer relationship database 208c recording information of a plurality of research organizations and a plurality of researchers in the specific technical field, based on which the search engine unit 208a can more easily monitor and search for relevant information.

In addition, in one exemplary embodiment of the present invention, the IP management module 208 further includes an IP trade and brokerage platform 208d. The IP management company 110 not only can more easily collect information on intellectual properties to be sold through the IP trade and brokerage platform 208d but also can sell unused intellectual properties of the fund company through the IP trade and brokerage platform 208d. For example, the IP management module 208 may search for license entities (i.e. interested buyer) of granted patents on behalf of the fund company 102 through the IP trade and brokerage platform 208d.

An example illustrating the process of purchasing and selling intellectual properties of the IP bank 100 is described as follows. Take the members 1˜5 and the fund company 102 as an example for illustration. However, the process may be applicable for operations among members 6˜15 and the fund companies 104 and 106.

For example, when the IP management module 208 of the IP management company 110 receives a request for search and analysis from the fund module 202 of the fund company 102, the IP management module 208, according to the request from the fund module 202, periodically collects, analyzes, and categorizes, through the second communication network 238, intellectual properties to be sold in the specific technical field to which the fund company 102 belongs and provides IP purchase suggestions to the fund module 202. Then, the fund module 202 sends the IP purchase suggestion to the members 1˜5 via the first communication network 232 and sends an IP purchase decision to the IP management module 208 after the members 1˜5 reach a decision.

Next, the IP management module 208 negotiates with the seller of the intellectual properties 252 according to the IP purchase decision from the fund module 202 via the second communication network 238. The fund module 202 purchases the appropriate intellectual properties (e.g. a patent portfolio) according to the negotiation outcome from the IP management module 208.

After purchasing the relevant intellectual properties, the fund company 102 forms an IP protection net for its members 1˜5 to defend them from infringement claims from other manufacturers. For example, if the member 1 is sued for patent infringement by the right claimer 1, the member 1 may send a transfer request to obtain intellectual properties owned by the fund company 102 to the fund module 202 of the fund company 102 via the first communication network 232. At this time, the fund module 202 sends a sale decision of the fund company 102 to the member 1 via the first communication network 232. When the fund company 102 approves the transfer request, the member 1 may own the obtained intellectual property within a contract period and use the ownership rights to fend off the right claimer 1.

In the exemplary embodiment of the present invention, the IP management company 110 assists the fund company in the planning, purchasing, selling, as well as licensing of intellectual properties, maintaining patents that have been granted, controlling patents that are in application, and responding to office actions during examination. Therefore, as mentioned above, the fund company has to pay a management fee in exchange for the service of the IP management company 110. As a result, in the present exemplary embodiment, the accounting data processing unit (e.g. the fund module 202c) of each fund module remits a management fee or commission to the IP management module 208.

It should be noted that, in the exemplary embodiment of the present invention, the fund modules 202, 204, and 206, and the IP management module 208 may be configured in a same server or may respectively be a separate server and connected via a communication network.

Based on the above, operations of the IP bank system 200 automatically facilitates to accomplish message communication, collection, analysis, as well as categorization of intellectual properties to be sold, and purchase and sale of intellectual properties in the IP bank 100.

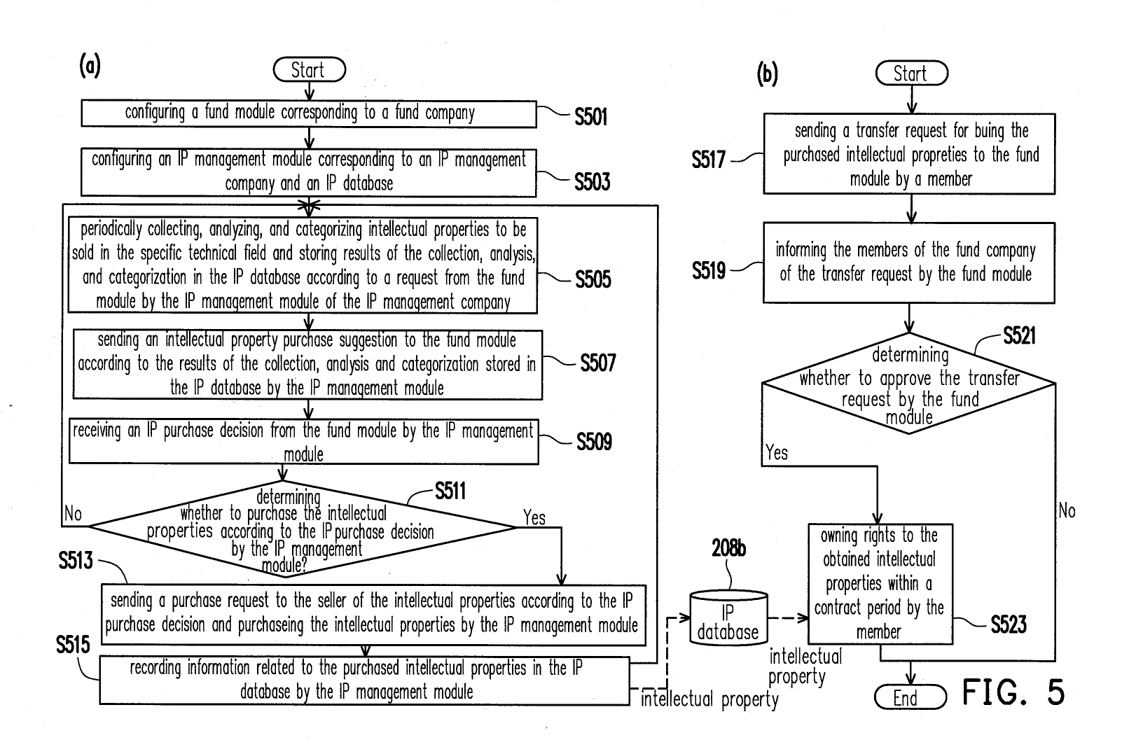

FIG. 5 is a flow chart illustrating operation of an IP management method according to one exemplary embodiment of the present invention. In particular, the present method is implemented by means of a computer/network system.

Referring to (a) in FIG. 5, first in step S501, a fund module (e.g. a fund module 202) is configured in correspondence to a fund company (e.g. a fund company 102). The fund company is established with capital raised from a plurality of members (e.g. members 1˜5) based on a specific technical field.

Next, in step S503, an IP management module (e.g. an IP management module 208) and an IP database (e.g. an IP database 208b) are configured. The IP management module corresponds to an IP management company.

Afterwards, in step S505, by request of the fund module, the IP management module of the IP management company periodically collects, analyzes, and categories intellectual properties to be sold in the specific technical field and stores the results of such collection, analysis, and categorization in the IP database. Then, in step S507, the IP management module proposes an IP purchase suggestion to the fund module according to the results of the collection, analysis, and categorization stored in the IP database.

Subsequently, in step S509, the IP management module receives the IP purchase decision from the fund module and, in step S511, determines whether to purchase the intellectual properties according to the IP purchase decision.

If it is determined in step S511 to purchase the intellectual properties, in step S513, the IP management module sends a purchase request to the seller of the intellectual properties and purchases the intellectual properties according to the IP purchase decision. In step S515, the IP management module records information related to the purchased intellectual properties in the IP database. Accordingly, the fund company can purchase an appropriate patent portfolio to form an IP protection net.

If a special event (e.g. a patent infringement lawsuit) occurs to a member, the member may search for useful intellectual properties through the IP management module of the IP management company and send a transfer request for obtaining the intellectually properties to the fund module in step S517. Next, in step S519, the fund module sends the transfer request to the members of the fund company.

In step S521, the fund module determines whether to approve the transfer request according to the decisions from all members of the fund company. If it is determined in step S521 to approve the transfer request, in step S523, the IP management company will assist the member obtain ownership rights to the obtained intellectual properties within a contract period.

As described above, in one exemplary embodiment of the present invention, the step S515 further includes non-exclusively licensing the purchased intellectual properties to the members of the fund module.

In addition, in another exemplary embodiment of the present invention, the step S503 includes configuring a technical developer relationship database and intellectual properties to be sold is periodically collected according to information of the technical developer relationship database. Furthermore, the method of FIG. 5 may include generating analysis reports on the patent layout of the specific technical field, consultation reports on IP laws, or suggestion reports on IP application, which are sent through a communication network. In this example, the fund module may further consider purchase of intellectual properties according to these reports.

In summary, in the present invention, by means of the IP bank formed with the fund company and the IP management company, intellectual properties required by the members can be precisely purchased to provide a powerful IP protection net to defend the members from infringement lawsuits. In addition, the purchase and sale of the intellectual properties can be effectively managed through the IP management system. In particular, when a single company conventionally manages intellectual properties thereof through an IP management firm, massive communication is generated between the two parties. However, the method of a plurality of companies entrusting an IP management company by means of a fund company to manage the intellectual properties can effectively make use of limited resources and significantly save costs. Particularly, by establishing an automatic module (i.e. the fund module and the IP management module), the fund company can effectively communicate relevant purchase decisions, sale decisions, analysis reports, etc. to all the members without hiring regular employees.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for managing intellectual properties through a computer/network system, comprising:
configuring at least one fund module, each of the at least one fund module corresponding to a fund company established with capital raised by a plurality of members based on a specific technical field, wherein each of the at least one fund module connects to the corresponding members via a first communication network;
configuring an intellectual property management module, corresponding to an intellectual property management company;
configuring an intellectual property database;
periodically collecting, analyzing, and categorizing intellectual properties to be sold in the specific technical field by means of a computer software and storing results of the collection, analysis, and categorization in the IP database according to a request from each of the fund module by the IP management module;
generating and sending an intellectual property purchase suggestion to the at least one fund module according to the results of the collection, analysis, and categorization stored in the IP database by the IP management module;
sending a purchase request to a seller of the intellectual properties via a second communication network, and purchasing at least one of the intellectual properties according to an intellectual property purchase decision generated by each fund module by the IP management module; and
recording information related to the purchased intellectual properties in the IP database by the IP management module,
wherein when at least one of the members sends a transfer request to obtain at least one of the intellectual properties purchased by the corresponding fund module via the first communication network, the corresponding fund module determines whether to approve the transfer request and sends a sale decision to the member sending the transfer request via the first communication network, and
when the corresponding fund module approves the transfer request, the member sending the transfer request own rights to the obtained intellectual properties within a contract period.

2. The method for managing intellectual properties through a computer/network system according to claim 1, wherein the members of each fund company own rights to use the purchased intellectual properties.

3. The method for managing intellectual properties through a computer/network system according to claim 1, wherein the members belonging to the same fund company have the same rights and members belonging to different fund companies have different rights.

4. The method for managing intellectual properties through a computer/network system according to claim 1, further comprising receiving management compensation from each fund module according to a predetermined rate by the IP management module.

5. The method for managing intellectual properties through a computer/network system according to claim 1, wherein the purchased intellectual properties comprises a plurality of granted patents or a plurality of patents in application.

6. The method for managing intellectual properties through a computer/network system according to claim 5, further comprising maintaining the granted patents and controlling status of the patents in application by the IP management module.

7. The method for managing intellectual properties through a computer/network system according to claim 5, further comprising searching for entities which may be licensed with the granted patents on behalf of each fund module via the second communication network by the IP management module, wherein the entities which may be licensed are not the members.

8. The method for managing intellectual properties through a computer/network system according to claim 1, further comprising configuring a technical developer relationship database recording information of a plurality of research units or a plurality of researchers of the at least one specific technical field.

9. The method for managing intellectual properties through a computer/network system according to claim 8, wherein the step of periodically collecting, analyzing, and categorizing the intellectual properties to be sold in the specific technical field comprises periodically collecting the intellectual properties according to the technical developer relationship database.

10. The method for managing intellectual properties through a computer/network system according to claim 1, further comprising configuring an IP trade and brokerage platform, wherein sellers wishing to sell the intellectual properties provide information of the intellectual properties through the IP trade and brokerage platform via the second communication network.

11. The method for managing intellectual properties through a computer/network system according to claim 1, further comprising generating an analysis report on patent map corresponding to the at least one specific technical field, a consultation report on IP laws, or a suggestion report on IP application and sending the analysis report on patent map, the consultation report on IP laws, or the suggestion report on IP application to the corresponding fund module via the first communication network by the IP management module.

12. The method for managing intellectual properties through a computer/network system according to claim 1, wherein if at least two of the members simultaneously send the transfer requests to obtain the same purchased intellectual properties, a member granted with the transfer request is generated through price bidding via the first communication network or the at least two of the members jointly obtain ownership to the same purchased intellectual properties.

13. An intellectual property (IP) bank system, comprising:
at least one fund module, each corresponding to a fund company having a plurality of members and capital supplied by the members of the fund company and each fund module connecting to the members through a first communication network; and
an IP management module, corresponding to an IP management company and connecting to the fund module via a connection for collecting, analyzing, and categorizing intellectual properties to be sold in a specific technical field through a computer software according to a request from the fund module,
wherein the IP management module sends an intellectual property purchase suggestion to each fund module according to the results of the collection, analysis, and categorization, each fund module is for sending an intellectual property purchase decision to the IP management module according to the IP purchase suggestion,
wherein the IP management module negotiates with the seller of the intellectual properties according to the IP purchase decision via a second communication network, each fund module purchases at least one of the intellectual properties according to results of the negotiation,
wherein when the members send transfer requests to obtain at least one of the purchased intellectual properties to the at least one fund module via the first communication network, the corresponding fund module determines whether to approve the transfer requests and sends sale decisions to the members sending the purchase requests via the first communication network, and when the corresponding fund module approves the transfer requests, the members sending the purchase requests own rights to the obtained intellectual properties within a contract period.

14. The IP bank system according to claim 13, wherein the members of each fund company own the rights to use the purchased intellectual properties.

15. The IP bank system according to claim 13, wherein the members belonging to the same fund company have the same rights and members belonging to different fund companies have different rights.

16. The IP bank system according to claim 13, each fund module remits management compensation to the IP management module according to a predetermined rate.

17. The IP bank system according to claim 13, wherein the connection is a third communication network.

18. The IP bank system according to claim 13, wherein the purchased intellectual properties comprises a plurality of granted patents or a plurality of patents in application.

19. The IP bank system according to claim according to claim 18, wherein the IP management module maintains the granted patents and controlling status of the patents in application.

20. The IP bank system according to claim 18, wherein the IP management module searches for entities which may be licensed with the granted patents on behalf of each fund module via the second communication network, and the entities which may be licensed are not the members.

21. The IP bank system according to claim 13, wherein the IP management module comprises a technical developer relationship database recording information of a plurality of research organizations or a plurality of researchers of the at least one specific technical field.

22. The IP bank system according to claim 21, wherein the IP management module periodically collect the intellectual properties to be sold according to the technical developer relationship database.

23. The IP bank system according to claim 13, further comprising an IP trade and brokerage platform, wherein sellers wishing to sell the intellectual properties provide information of the intellectual properties to the IP management module through the IP trade and brokerage platform via the second communication network.

24. The IP bank system according to claim 13, wherein the corresponding fund module sends return transfer requests to the members who have obtained the obtained intellectual properties via the second communication network after the contract period expires, and the members receiving the return transfer requests have to send a return sale confirmation to the corresponding fund module via the second communication network.

25. The IP bank system according to claim 13, wherein the IP management module generates an analysis report on patent layout corresponding to each of the at least one specific technical field, a consultation report on IP laws, or a suggestion report on IP application and sends the analysis report on patent layout, the consultation report on IP laws, or the suggestion report on IP application to the corresponding fund module via the first communication network.

26. The IP bank system according to claim 13, wherein the members engage in legal proceedings based on the intellectual properties obtained from the corresponding fund company.

27. The IP bank system according to claim 15, wherein the IP management module comprises an intellectual property (IP) database for storing the purchased intellectual properties of each fund module.

28. The IP bank system according to claim 13, wherein if at least two of the members simultaneously send the transfer requests to the corresponding at least one fund module for obtaining the same purchased intellectual properties, the at least one fund module generates a member granted with the transfer request through price bidding via the first communication network.
